(19) United States
(12) Patent Application Publication
(10) Pub. No.: US 2013/0135863 A1
(43) Pub. Date: May 30, 2013

(54) DISPLAY DEVICE

(71) Applicants: Mario Melkes, Koppl (AT); Jurgen Schieren, Munchen (DE)

(72) Inventors: Mario Melkes, Koppl (AT); Jurgen Schieren, Munchen (DE)

(73) Assignee: SkiData AG, Grodig/Saizburg (AT)

(21) Appl. No.: 13/614,091

(22) Filed: Sep. 13, 2012

(30) Foreign Application Priority Data
Nov. 25, 2011 (EP) 11 190 736.6

(51) Int. Cl. F21V 1/00

(52) U.S. Cl. 362/248

(57) ABSTRACT

A display device (1) for displaying numbers and/or letter combinations and symbols is proposed, having at least one LED circuit board (3) comprising a plurality of individually controllable RGB LEDs (4), wherein the surface (2) of the display device (1) is produced from a translucent polycarbonate and on the side facing away from or towards the at least one LED circuit board (3), has a covering non-transparent lacquer coating (5), which is removed at the points corresponding to the position of the LEDs (4) of the at least one LED circuit board (3) in the assembled condition of the display device (1), making the display device (1) translucent at these points.

### CROSS REFERENCE TO RELATED APPLICATIONS

This application asserts priority from application EP 11 190 736.6 filed on Nov. 25, 2011, which is incorporated herein by reference.

### FIELD OF THE INVENTION

The present invention relates to a display device for displaying numbers and/or combinations of letters and symbols, in particular traffic symbols.

### BACKGROUND OF THE INVENTION

From the prior art display devices for displaying combinations of numbers and/or letters, as well as traffic symbols, are known. Such display devices typically include LEDs, which when appropriately driven can represent text items or for example, arrows. In these devices one colour is assigned to one LED, so that a limited number of symbols can be represented. In addition, the display devices of the above-mentioned type known from the prior art have the disadvantage that the LEDs are visible even when they are not lit, which under certain circumstances can irritate mad uses in strong sunlight, since in infavourable light conditions the open LED structures can lead to the appearance of invalid symbols or combinations of numbers and/or letters from the point of view of an observer. Moreover, the open LED-structures known from the prior art do not satisfy today's design requirements.

The object of the present invention is to specify a display device for displaying combinations of numbers and/or letters and symbols, which allows a variety of combinations of numbers and/or letters and symbols to be represented with multiple colours and in which the LEDs used are visible only when they are activated, i.e. if they are lit. In particular, the display device according to the invention is to have a homogeneous surface during a period of inactivity, so that the display of invalid combinations of numbers and/or letters and symbols is avoided.

This object is achieved by the characterizing features of Claim 1. Further embodiments and advantages are evident from the dependent claims.

Accordingly, a display device for displaying numbers and/or letter combinations and symbols is proposed, which has at least one LED circuit board comprising a plurality of RGB LEDs which are individually controllable and in the context of an extension, dimmable in each of the three RGB-colours, with the surface of the display device, i.e. the side that is used to display numbers and/or letter combinations and symbols, being produced from a translucent polycarbonate. The individually controllable LEDs can have a central control unit or be driven by decentralised control units, each integrated into the LEDs or in the vicinity of the LEDs.

Decentralised control units integrated into the LEDs or in the vicinity of the LEDs allow the assembly space required for conductor tracks to be reduced, which results in a reduction of the material costs and thus the production costs, and/or in a higher packing density. LEDs controllable by integrated, decentralised control units need only be supplied with electricity and a data bus and can be provided in a parallel circuit arrangement.

Because the LEDs can be dimmed individually in each of the three RGB colours, the overall brightness of the display device can be controlled. In addition, the range of colours achievable can be extended by shading in added colours.

Furthermore, the layer of translucent polycarbonate forming the surface of the display device, on the side thereof facing away from or towards the at least one LED circuit board has a covering non-transparent coat of lacquer, wherein, by removal of the lacquer at the points corresponding to the position of the LEDs of the at least one LED circuit board in the assembled condition of the display device, the display device becomes translucent at these points. This ensures that the surface of the display device has a homogeneous surface during periods of inactivity. The LEDs used are only visible when they are activated, so that from the perspective of an observer the display of invalid symbols, or combinations of numbers and/or letters is prevented.

The LEDs are preferably arranged in a honeycomb structure, so that removal of the lacquer layer reveals a corresponding honeycomb structure.

The lacquering can be effected, for example, using lasers or other appropriate methods.

In accordance with an advantageous extension of the invention the at least one LED circuit board is designed as a flexible printed circuit board which is connected to the surface of the display device such that it assumes the shape of the surface of the display device, so that a constant luminance is ensured, even on a curved surface of the display device. In this way, the surface of a display device according to the invention can be designed to be curved while maintaining a constant attainable luminance, so that design requirements can be met.

Using the conception according to the invention of using LEDs that can be activated individually means that the display of arbitrary combinations of numbers and/or letters, and of arbitrary symbols, for example traffic symbols, is possible in the desired colour, without the need to provide multiple display devices for this purpose. Due to the free configurability of the display device that can now be obtained, the device can be used for a wide variety of purposes. The displayable symbols can be traffic symbols or warning symbols, blinking or warning lights. The display device according to the invention is preferably integrated into a stationary infrastructure.

In accordance with a preferred extension of the invention, the display device is used as a lane indicator light for a vehicle barrier, in this case, it is possible to display direction arrows, for example green arrows or an X-symbol coloured in red. In addition, the display device according to the invention can be driven such that a flashing warning light is produced by a movement of the barrier, whereby the requirements of the legislative authorities can be met. In addition, the display of scrolling text, logos or moving symbols is also made possible.

The invention will he explained in further detail in the following text with the aid of examples shown in the figures.

### BRIEF DESCRIPTION OF THE DRAWINGS

In the Figures:

FIG. 1 a cross-sectional view of a display device designed according to the invention;

FIG. 2 a detail view of the region B of FIG. 1 to illustrate the structure of the display device;

FIG. 3 a perspective view of a vehicle barrier with an integrated lane indicator light, which is formed by a display device according to the invention; and

FIG. 4 a plan view of the lane indicator light according to FIG. 4.

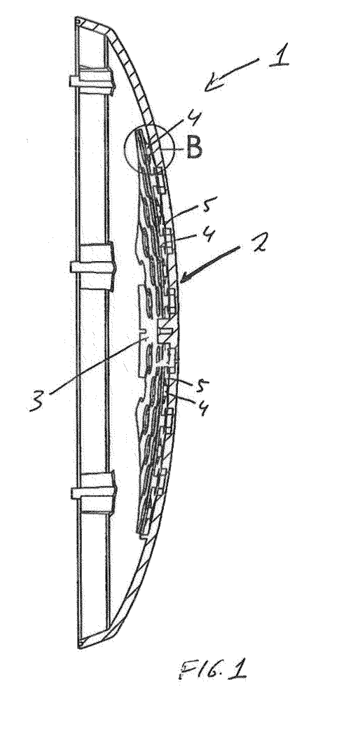

FIG. 1 shows a display device 1 according to the invention for displaying combinations or numbers and/or letters and symbols, which has a convex surface 2 which is used for displaying combinations of numbers and/or letters, and symbols, for example, traffic symbols.

The display device 1 in accordance with FIG. 1 has an LED circuit hoard 3 comprising a plurality of RGB-LEDs 4 which are individually controllable and dimmable in each of the three RGB-colours, and which is implemented as a flexible printed circuit board so that it can assume the convex shape of the surface 2 of the display device 1, resulting in a constant luminance on the surface 2. In the example shown the LED circuit board 3 is bolted to the convex surface 2.

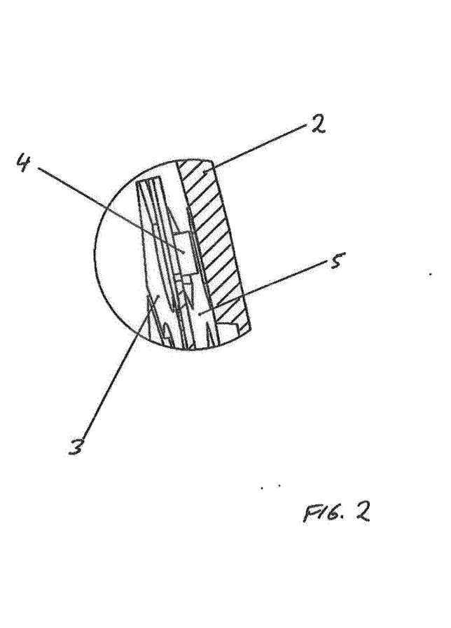

According to the invention, the surface 2 of the display device 1 is produced from a translucent polycarbonate and on the side facing the LED board 3 has a covering non-transparent lacquer coating 5, which is removed at the points corresponding to the position of the LEDs 4 of the LED circuit hoard 3 in the assembled condition of the display device 1, making the display device 1 translucent at these points. This is illustrated by FIG. 2. Due to this, during a period of inactivity the display device 1 according to the invention has a homogeneous surface 2, so that from the point of view of an observer of the display device 1, the display of invalid, i.e. undesired, numbers and/or letter combinations and symbols is avoided. Advantageously, the LEDs are only visible when they are activated.

Advantageously, a brightness sensor can he provided, wherein based on the signals from the light sensor, the brightness of the display of the display device 1 is adjusted to match the ambient light using the controller of the RGB LEDs 4 which are dimmable in each of the three RGB colours, in order to ensure optimum readability.

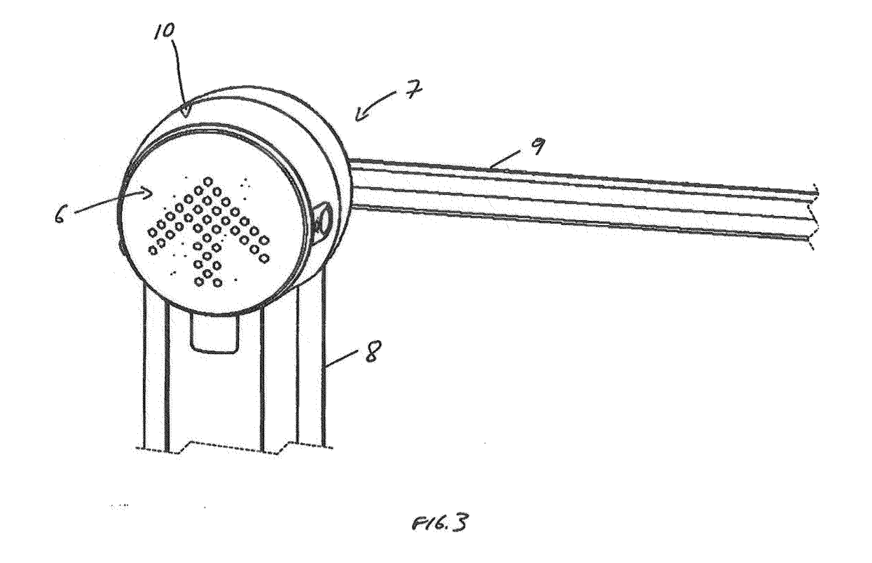

The subject matter of FIG. 3 is a lane indicator light 6 of a vehicle barrier 7, which is formed by a display device 1 designed according to the invention. In FIG. 3 the barrier column and the barrier boom, which can be pivoted between the closed and the open position, are designated by 8 and 9 respectively, with the barrier display head being provided with the reference numeral 10. The lane indicator light 6 is arranged on the side of the barrier display head 10 which faces the oncoming vehicles of the vehicle barrier 1.

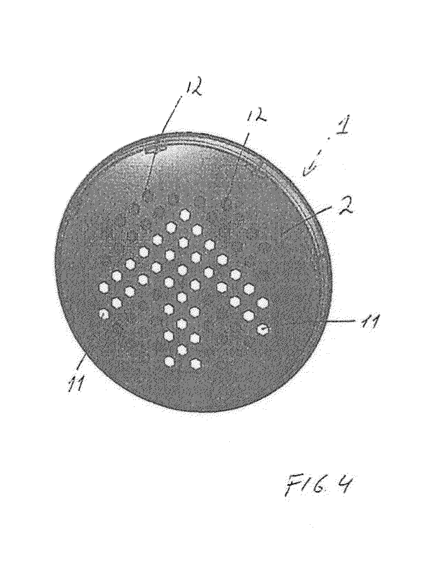

In the example shown in FIG. 3 a green arrow is displayed as a result of appropriate activation of the LEDs 4 of the display device 1. Advantageously, due to the design according to the invention, only the LEDs that are activated are visible in order to form the green arrow. This is also illustrated by FIG. 4; in this case the visible LEDs which form the arrow are given the reference numeral 11, with the LEDs not used for displaying the arrow designated by reference numeral 12.

1. Display device (1) for displaying numbers and or letter combinations and symbols, characterized in that it has at least one LED circuit board (3) comprising a plurality of individually controllable RGB LEDs (4), wherein the surface (2) of the display device (1) is produced from a translucent polycarbonate and has on the side facing away from or towards the at least one LED circuit board (3) a covering non-transparent lacquer coating (5), which is removed at the points corresponding to the position of the LEDs (4) of the at least one LED circuit board (3) in the assembled condition of the display device (1), thereby making the display device (1) translucent at these points.

2. Display device (1) for displaying numbers and/or letter combinations and symbols, according to claim 1, characterized in that the lacquer coating (5) is removed by means of lasers.

3. Display device (1) for displaying numbers and or letter combinations and symbols, according to claim 1, characterized in that the at least one LED circuit board (3) is implemented as a flexible printed circuit board, which is connected to the surface (2) of the display device (1) such that it assumes the shape of the surface (2) of the display device (1), so that a constant luminance is ensured on the surface (2) of the display device (1).

4. Display device (1) for displaying numbers and/or letter combinations and symbols, according to claim 3, characterized in that the surface of the display device (1) is designed to be curved.

5. Display device (1) or displaying, numbers and/or letter combinations and symbols, according to claim 1, characterized in that the LEDs (4) are arranged in a honeycomb structure.

6. Display device (1) for displaying numbers and/or letter combinations and symbols, according to claim 1, characterized in that the LEDs (4) are dimmable in each of the three RGB colours.

7. Use of the display device (1) according to claim 1 as a lane indicator light (6) of a vehicle barrier (7).
